(19) United States
(12) Patent Application Publication
(10) Pub. No.: US 2008/0106623 A1
(43) Pub. Date: May 8, 2008

(54) SOLID-STATE IMAGING DEVICE AND IMAGING APPARATUS

(76) Inventor: Hiroyuki Oshima, Osaka-shi (JP)

Correspondence Address: BIRCH STEWART KOLASCH & BIRCH, PO BOX 747, FALLS CHURCH, VA, 22040-0747, US

(21) Appl. No.: 11/923,157

(22) Filed: Oct. 24, 2007

(30) Foreign Application Priority Data
Nov. 6, 2006 (JP) P2006-300274

(51) Int. Cl. H04N 5/335

(52) U.S. Cl. 348/294; 348/E05.091

(57) ABSTRACT

A solid-state imaging device is provided and includes: an imaging area including unit pixel row elements arranged in a two-dimensional array, each of the unit pixel row elements including a pixel row in which a plurality of pixels are arranged, a charge transfer path that transfers signal charges detected by the pixels, and a charge-voltage conversion section disposed at an end of the charge transfer path, the conversion section outputting a voltage signal in accordance with an amount of the signal charges; a horizontal scanning circuit that designates a horizontal position, within the imaging area, of a unit pixel row element to read the voltage signal; and a vertical scanning circuit that designates a vertical position of the unit pixel row element with the imaging area.

### BACKGROUND OF THE INVENTION

1. Field of the Invention

The present invention relates to a solid-state imaging device and an imaging apparatus, and more particularly to a solid-state imaging device and an imaging apparatus, which can randomly access a signal detected by a pixel and is capable of global shutter.

2. Description of Related Art

As an image sensor mounted on a digital camera or the like, a CMOS type and a CCD type are mostly employed. The CMOS type has an advantage that it can read a detected signal of each pixel by random access, but the S/N ratio is worse and the global shutter is more difficult than the CCD type.

On the contrary, the CCD type has an advantage that the global shutter is easy and the S/N ratio is good, but the detected signal of a pixel can not be read fast. Particularly, in the recent CCD type solid-state imaging device in which several million pixels or more are usually mounted, the number of transfer steps on a horizontal charge transfer path is increased, and the driving of the horizontal charge transfer path causes a bottleneck in the power consumption or reading speed.

Thus, a solid-state imaging device in which the CCD type and the CMOS type are integrated has been proposed in JP-A-2002-135656. This solid-state imaging device is basically an interline type CCD and has a constitution of reading and transferring a detected signal of each pixel on the vertical charge transfer path, and converting a signal charge transferred on each vertical charge transfer path into a voltage signal through charge detection means provided at the end of each vertical charge transfer path, in which the horizontal charge transfer path is omitted.

The solid-state imaging device as described in JP-A-2002-135656 does not have a horizontal charge transfer path, and overcomes disadvantages with a usual CCD type solid-state imaging device in the power consumption or reading speed. However, pixels arranged in the vertical direction can not be randomly accessed, and when the number of transfer steps on the vertical charge transfer path is increased because of multiple pixels, the driving of the vertical charge transfer path causes a bottleneck.

### SUMMARY OF THE INVENTION

An object of an illustrative, non-limiting embodiment of the invention is to provide a solid-state imaging device and an imaging apparatus having the solid-state imaging device, which is capable of global shutter and random access, and which the S/N ration is good and the driving of a vertical charge transfer path does not cause a bottleneck.

According to an aspect of the invention, there is provided a solid-state imaging device including:

an imaging area including unit pixel row elements arranged in a two-dimensional array, each of the unit pixel row elements including a pixel row in which a plurality of pixels are arranged, a charge transfer path that transfers signal charges detected by the pixels, and a charge-voltage conversion section disposed at an end of the charge transfer path, the conversion section outputting a voltage signal in accordance with an amount of the signal charges;

a horizontal scanning circuit that designates a horizontal position, within the imaging area, of a unit pixel row element to read the voltage signal; and

a vertical scanning circuit that designates a vertical position of the unit pixel row element with the imaging area.

In the solid-state imaging device, the charge-voltage conversion section includes a transistor circuit, and the transistor circuit may be disposed as a pixel lacking part in the same row as the plurality of pixels

In the solid-state imaging device, the charge-voltage conversion section includes a transistor circuit, and the transistor circuit may be shared with a plurality of first unit pixel row elements adjacent to one another.

In the solid-state imaging device, the plurality of first unit pixel row elements adjacent to one another may be arranged in a direction perpendicular to the pixel row, and the transistor circuit shared with the plurality of first unit pixel row elements may be disposed in a space between the first unit pixel row elements and second unit pixel row elements adjacent to the first unit pixel row elements in a direction of the pixel row.

The solid-state imaging device may further includes a signal processing circuit that processing an image signal read from the imaging area, the signal processing circuit being integrated on a chip mounting the imaging area, the horizontal scanning circuit, and the vertical scanning circuit.

According to an aspect of the invention, there is provided an imaging apparatus including: the solid-state imaging device; and a section that collectively resets unwanted charges accumulated on the charge transfer path in the imaging area.

According to an aspect of the invention, there is provided an imaging apparatus including: the solid-state imaging device; and a control section that outputs a control instruction to the vertical scanning circuit and the horizontal scanning circuit to randomly access an image signal detected by the charge-voltage conversion section for each of the unit pixel row elements.

According to an aspect of the invention, there is provided an imaging apparatus including: the solid-state imaging device; and a control section that instructs a pixel thinning read or pixel adding read for each of the unit pixel row elements.

According to an aspect of the invention, there is provided an imaging apparatus including: the solid-state imaging device, and a signal processing section that interpolates an image signal of the pixel lacking part with image signals read from pixels around the pixel lacking part.

### BRIEF DESCRIPTION OF THE DRAWINGS

The features of the invention will appear more fully upon consideration of the exemplary embodiments of the inventions, which are schematically set forth in the drawings, in which:

FIG. 1 is a block diagram of a digital camera mounting a solid-state imaging device according to an exemplary embodiment of the present invention;

FIG. 2 is a surface diagram of the solid-state imaging device as shown in FIG. 1;

FIG. 3 is a surface diagram of an imaging area as shown in FIG. 2;

FIG. 4 is a cross-sectional view with a transistor circuit diagram of a semiconductor formed with a unit pixel row element as shown in FIG. 3;

FIG. 5 is a timing chart for driving the solid-state imaging device as shown in FIG. 2;

FIG. 6 is an explanatory view for explaining an arrangement and the signal interpolation of pixel signal read from the solid-state imaging device as shown in FIG. 3;

FIG. 7 is an explanatory view for reading signals by thinning pixels from the solid-state imaging device as shown in FIG. 3; and

FIG. 8 is a view showing eight unit pixel row elements of a solid-state imaging device according to another exemplary embodiment of the invention,

wherein reference numerals in the drawings are set forth below.
100: solid-state imaging device
101: imaging area
102: vertical scanning circuit
103: horizontal scanning circuit
105: selection circuit
106: output amplifier
110, 130: unit pixel row element
111: pixel (photoelectric converter)
112: vertical charge transfer path
113: charge-voltage conversion part
114: transistor circuit (pixel lacking part) constituting FDA
116, 117, 118: MOS transistor
124: charge accumulation part
125: floating diffusion (FD) part
126: reset drain (RD) part

### DETAILED DESCRIPTION OF THE INVENTION

According to an embodiment of the invention, each unit pixel row element can be randomly accessed, whereby image signals for imaging can be read fast, and it is basically a CCD type is basic, whereby the S/N ratio can be high and the global shutter can be easy. Further, it is unnecessary to increase the number of transfer steps on a charge transfer path in a unit pixel row element even if there are more multiple pixels, and thus the charge transfer path does not cause a bottleneck in the reading.

Exemplary embodiments of the present invention will be described below with reference to the drawings.

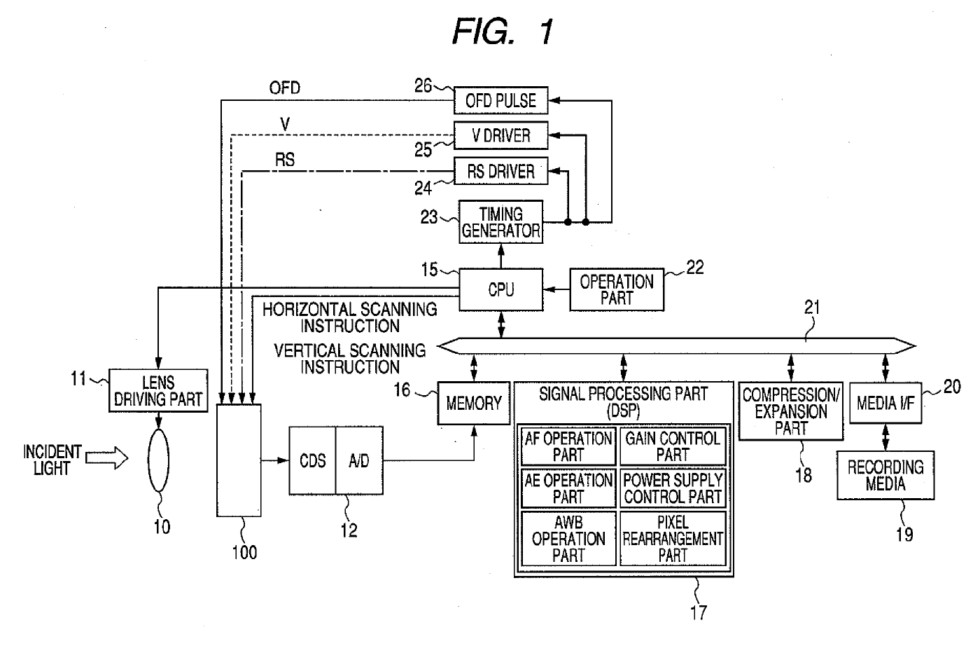

FIG. 1 is a block diagram of a digital camera mounting a solid-state imaging device according to an exemplary embodiment of the invention. The digital camera includes a solid-state imaging device 100 as will be detailed later, an imaging lens 10 disposed in front of the solid-state imaging device 100, a lens drive part 11 for controlling the driving of the imaging lens 100 to a focus position or zoom position based on an instruction from a CPU 15, and a preprocessing part 12 for capturing an image signal outputted from the solid-state imaging device 100 and performing a correlation double sampling (CDS) process and an analog-digital conversion (A/D) process.

In an illustrated example, a noise signal serial output method for outputting signals in the order from the last stage amplifier of the solid-state imaging device, the CDS and the A/D is employed, but another output method such as a column A/D method may be employed.

An electric control system of the digital camera includes a CPU 15 for generally controlling the overall digital camera, a memory 16 for capturing a digital image signal outputted from the preprocessing part 12, a signal processing part (DSP) 17 for performing the signal processing by capturing the digital image signal from the memory 16, a compression expansion part 18 for compressing and expanding the digital image signal to the image signal such as JPEG, a media interface (I/F) 20 for storing or reading the JPEG image signal in or from a recording media 19, and a bus 21 for interconnecting them one another.

The signal processing part 17 performs the processing performed by the ordinary digital camera, for example, an auto focus (AF) operation processing, an automatic exposure (AE) operation processing, or an auto white balance (AWB) processing, and performs the gain control, a pixel rearrangement process, and the power control.

This digital camera further includes an operation part 22 for inputting an instruction from the user into the CPU 15, a timing generator 23, an RS driver 24, a V driver 25 and an OFD pulse generating part 26.

The timing generator 23 generates various kinds of timing, based on an instruction from the CPU 15, to output a timing signal to each driver circuit 24, 25 or 26. Based on the timing signal, the RS driver circuit 24 outputs a reset signal (RS), the V driver 25 outputs a vertical transfer pulse (V) on the vertical charge transfer path, and the OFD pulse generating part 26 outputs an overflow drain pulse (OFD) to the solid-state imaging device 100.

Also, the CPU 15 outputs a scanning instruction signal to a vertical scanning circuit or a horizontal scanning circuit, as will be described later, mounted on the solid-state imaging device 100, and performs the output control and pixel adding read control for the image signal of the solid-state imaging device 100.

A signal processing circuit such as the preprocessing part 12 or signal processing part 17 may be integrated on the same chip as the chip for mounting the solid-state imaging device 100. The timing generator 23, the RS driver 24, the V driver 25, and the OFD pulse generating part 26 may be also integrated together on the chip of the solid-state imaging device 100.

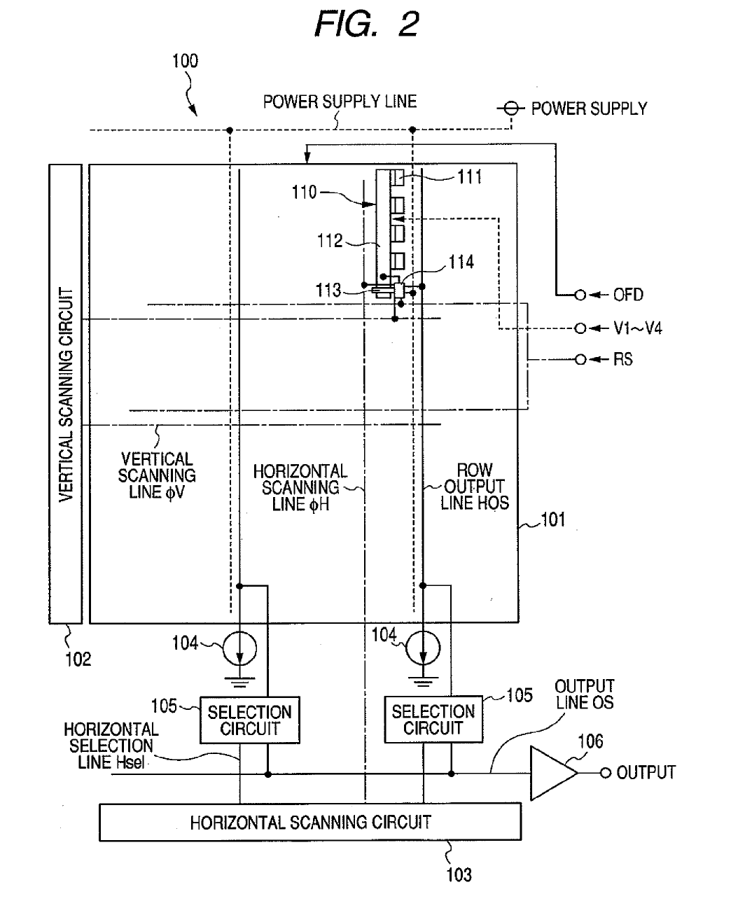

FIG. 2 is a typical surface view of the solid-state imaging device 100. On the surface portion of a semiconductor substrate, there are provided an imaging area 101, and a power line, a vertical scanning line φV, a horizontal scanning line φH, and a row output line HOS laid on the imaging area 101, a vertical scanning circuit 102 to which the vertical scanning line φV is connected, a horizontal scanning circuit 103 to which a horizontal selection line Hsel and the horizontal scanning line φH are connected, a current source 104 connected to each row output signal line HOS, a selection circuit 105, provided for each row output line HOS, for outputting an output signal of the row output line HOS to an output line OS when it is selected by the horizontal selection line Hsel, and an output amplifier 106 provided at the end of the output line OS.

The terms “vertical” and “horizontal” are used for explanation, but simply mean the “one direction” and “direction perpendicular to the one direction” on the surface of semiconductor substrate.

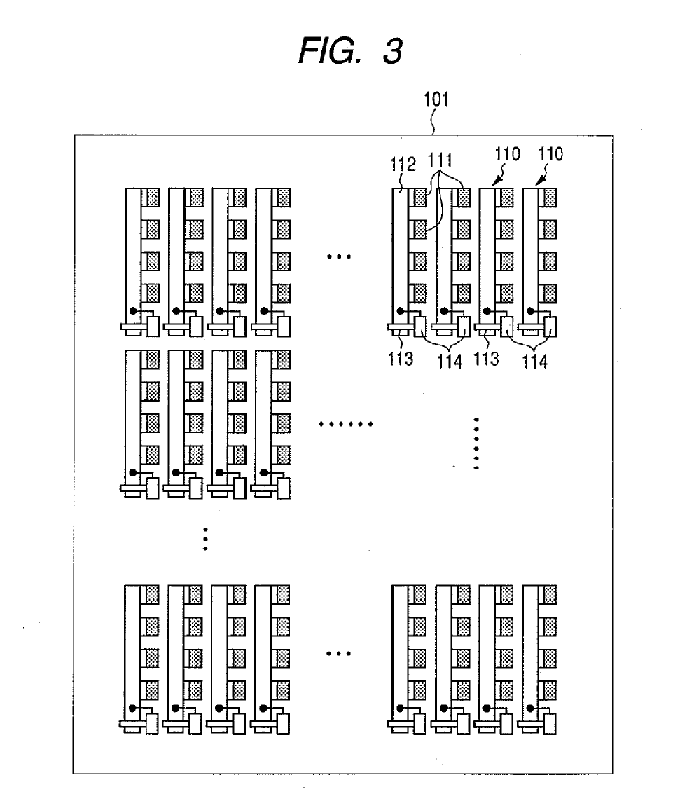

FIG. 3 is a surface diagram of the imaging area 101. On the surface of the imaging area 101, a plurality of unit pixel row elements 110 with the same constitution are arranged like a matrix. The unit pixel row element 110 in the illustrated embodiment has four pixels (photodiode: photoelectric converter) 111 arranged in the vertical direction, a vertical charge transfer path (VCCD) 112 provided at the end of these four pixels 111, and a charge-voltage conversion part 113 provided at the end of the vertical charge transfer path 112 in the transfer direction.

A transistor circuit part 114 of the charge-voltage conversion part 113 is provided at the fifth pixel position, assuming that the unit pixel row element 110 is provided with the fifth pixel in the vertical direction. And each unit pixel row element 110 is arranged in the imaging area 101 so that the first pixel of the next unit pixel row element 110 in the vertical direction may be at the sixth pixel position.

In this embodiment, since a transistor circuit 114 is provided in a portion where the fifth pixel is provided, the area per floating diffusion amplifier including the transistor circuit can be increased, whereby there is an advantage that the amplifier performance is improved and the S/N radio is increased.

As a result of the above pixel array, the pixels 111 are arranged like a square lattice in the imaging area 101 of this embodiment, so that a pixel lacking portion arises at every fifth pixel in the vertical direction. The correction for this pixel lacking portion will be described later.

Though the pixels 111 are arranged like a square lattice in the solid-state imaging device 100 in the illustrated embodiment, this embodiment may be directly applied to a so-called honeycomb pixel array in which the pixels in the even-numbered lines are displaced by ½ pitch with respect to the pixels in the odd-numbered lines, as described in JP-A-10-136391, for example. In this case, each pixel array provided in each unit pixel row element is not linear, but may be arranged in a zigzag. Also, the vertical charge transfer path 112 is not linear but becomes serpentine in a zigzag, which is of no matter.

Also, in this embodiment, one unit pixel row element 110 is provided with four pixels. However, the number of pixels may be any n (n is a positive integer of 2 or greater) smaller than the total number of pixels arranged in the vertical direction of the imaging area 101.

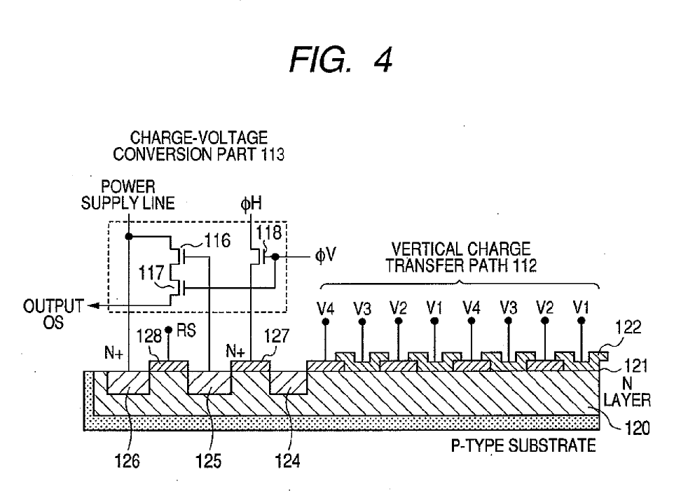

FIG. 4 is a cross-sectional view of an end portion of the unit pixel row element 110. An n-type impurity layer 120 is formed as a buried channel of the vertical charge transfer path 112 on the surface portion of a p well layer provided on a p-type or n-type substrate surface portion, and a gate insulation film 121 is formed on its surface. A vertical transfer electrode film 122 constituting the vertical charge transfer path 112 is stacked on the gate insulation film 121 with a well known constitution. In the illustrated embodiment, four phase driving transfer pulses V1 to V4 are applied to the transfer electrode film 122.

On the end part of the vertical charge transfer path 112, a charge accumulation part 124 formed of an n-type high density impurity layer, a floating diffusion (FD) part 125 and a reset drain (RD) part 126 are provided with spacing in this order. And a horizontal scanning electrode film 127 is stacked on the gate insulation film 121 between the charge accumulation part 124 and the FD part 125, and a reset electrode film 128 is stacked on the gate insulation film 121 between the PD part 125 and the RD part 126.

The transistor circuit part 114 of the charge-voltage conversion part 113 has three MOS transistors 116, 117 and 118. The transistors 116 and 117 are connected in series between the reset drain part 126 and the power line, the gate of the transistor 116 is connected the FD part 125, and the output end of the transistor 117 is connected to the row output line HOS of FIG. 2. The output end of each transistor 117 of each unit pixel row element 110 provided on the same vertical line in the imaging area 101 is connected the common row output line HOS corresponding to the vertical line.

The gate of the transistor 118 provided between the horizontal scanning line φH and the horizontal scanning electrode line 127 in FIG. 2 is connected to the gate of the transistor 117, and connected to the vertical scanning line φV. The transistor 118 of each unit pixel row element 110 provided on the same vertical line in the imaging area 101 is connected to the common horizontal scanning line φH corresponding to the vertical line and the gate of the transistor 118 of each vertical transfer pixel row element 110 provided on the same horizontal line of the imaging area 101 is connected to the common vertical scanning line φV corresponding to the horizontal line.

When the vertical transfer pulses V1 to V4 are applied from the V driver 25 in FIG. 1 to the vertical transfer electrode film 122 of each vertical transfer pixel row terminal 110, a reset pulse RS is applied from the RS driver 24 in FIG. 1 to the reset electrode film 128 of FIG. 4, and when an OFD pulse is applied from the OFD pulse generating part 26 in FIG. 1 to the semiconductor substrate of the solid-state imaging device 100, unwanted charges within each pixel 111 are discarded to the substrate side, so that an electronic shutter becomes “open”.

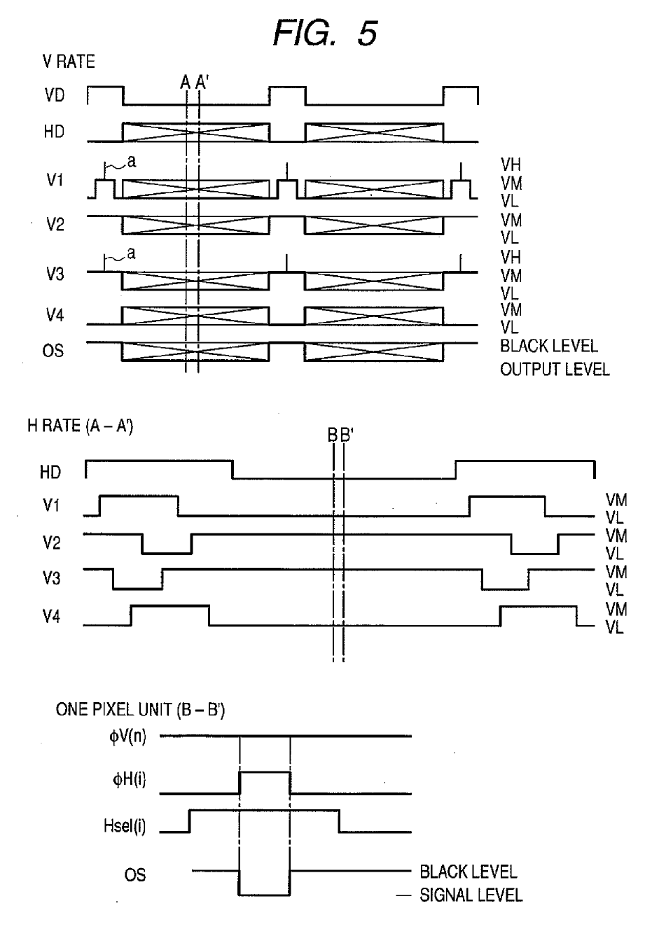

FIG. 5 is a timing chart showing the driving patterns where the subject image is taken by the digital camera mounting the solid-state imaging device 100 with the above constitution. The timing charts of the V rate and the H rate on the upper two stages are the same as the driving patterns of the ordinary CCD type solid-state imaging device.

The solid-state imaging device 100 of this embodiment, like the ordinary CCD type solid-state imaging device, firstly discards unwanted charges of each pixel by the OFD pulse, and sweeps fast and drives the vertical charge transfer path 112 to empty the vertical charge transfer path 112.

Each pixel 111 of the solid-state imaging device 100 accumulates signal charges in accordance with the light received amount. If a read pulse a is applied to the transfer electrode film, a signal charge is read from the pixel 111 to the vertical charge transfer path 112, and if the vertical transfer pulses V1 to V4 are applied to the vertical charge transfer path 112, this signal charge is transferred in the direction of the charge accumulation part 124.

A signal charge transferred to the charge accumulation part 124 in FIG. 4 is passed to the FD part 125, when an application voltage to the electrode film 127 is turned on, so that a signal according to the signal charge amount of this FD part 125 is outputted as an image signal from the transistor 117. Thereafter, if a reset signal RS is applied to the reset electrode film 128, the signal charge of the FD part 125 is passed to the reset drain 126, so that this signal charge (electron) is discarded to a high voltage power source.

This reading of an output signal OS is performed in such a way that the unit pixel row element 110 to be read is decided by the logical product of the vertical scanning signal φV and the horizontal scanning signal φH, in which if the row is selected by the horizontal selection signal Hsel, an output signal of the pixel row unit 110 is outputted from the output amplifier 106, as shown in the timing charts on the lowest stage in FIG. 5.

In this way, each unit pixel row element 110 can be randomly accessed in the solid-state imaging device 100 of this embodiment. Also, since the CCD type is fundamental, the global shutter is easy, and the S/N ratio can be kept high. And even if the smear occurs, the influence of smear can be suppressed to the length of four pixels, because the length of the vertical charge transfer path 112 is four pixels. Therefore, the number of pixels provided for the unit pixel row element 110 may be, for example, within several pixels, with which the smear is less conspicuous.

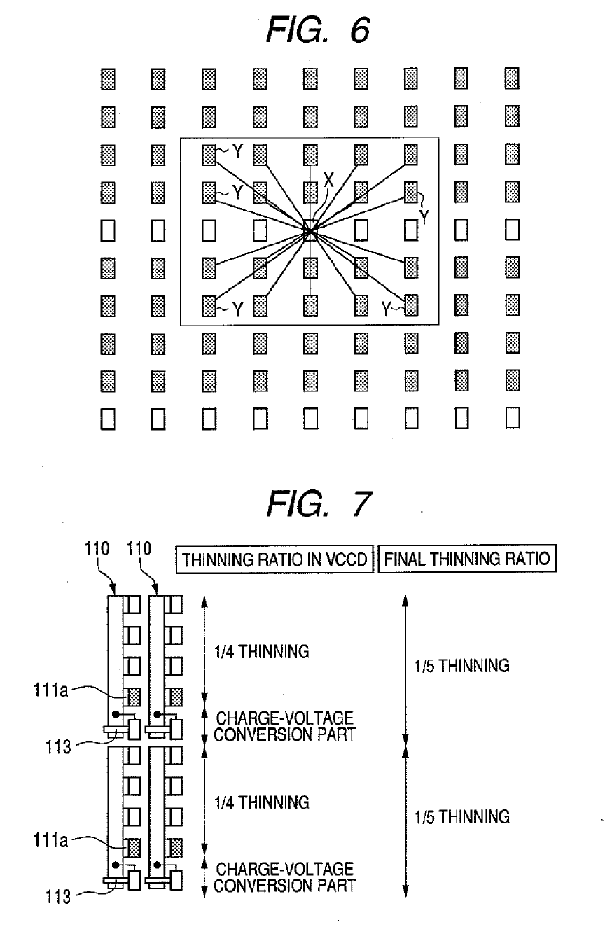

FIG. 6 is a view showing the signal arrangement of pixels 111 read from the solid-state imaging device 100. Since the amplifier 114 of the charge-voltage conversion part 113 is provided for every five pixels in the vertical direction as described above, the image signal at this position is in a lacking state.

Thus, in this embodiment, the image signal at this image signal lacking position is processed in the same way as the defective pixel correction in the background art. That is, it is interpolated by the image signals of the pixels Y (20 pixels in the illustrated example) except for lacking pixels around the image signal dropout position X. Thereby, the high definition image can be picked up.

In this embodiment, the thinning pixel reading is allowed, in addition to the reading of all the pixels. For example, in imaging a moving picture, it is required to read the picked up image by thinning the pixels at high speed. In this case, the signal of the pixel 111a (shaded pixel) nearest to the charge-voltage conversion part 113 in each unit pixel row element 110 is only read, thereby thinning the pixels to one-fourth (thinning the pixels to one-fifth as a whole: the signal at the dropout position 114 is not obtained) to permit the fast reading, as shown in FIG. 7.

Or in the solid-state imaging device 100 of this embodiment, it is possible to provide a mode for reading a signal of adding the signals of four pixels for each unit pixel row element 110. Thereby, the highly sensitive image can be picked up.

In this way, in the solid-state imaging device of this embodiment, since the thinning of pixels or the addition of pixels is easy, the number of pixels for the unit pixel row element may be decided at the maximum pixel thinning ratio or pixel addition number according to the specification, besides the smear.

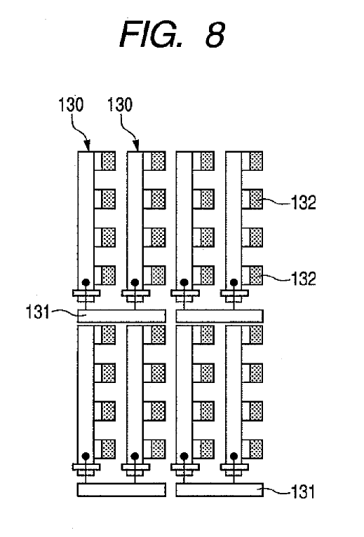

FIG. 8 is a view of the unit pixel row elements 130 provided in the solid-state imaging device according to another exemplary embodiment of the invention. In this embodiment, a floating diffusion (transistor circuit) 131 common to two unit pixel row elements arranged in the horizontal direction is provided, whereby the area of the transistor circuit part 131 is increased.

If the area of each amplifier is increased, the amplifier performance is improved, and the S/N ratio can be further increased.

Also, since the transistor circuit part 131 is provided between the unit pixel row element 130 on the upper stage and the unit pixel row element 130 on the lower stage in the vertical direction, the installation width of the transistor circuit part 131 can be narrowed, the pixels 132 can be arranged evenly in the imaging area 101 without providing the pixel signal dropout position 114 as shown in FIG. 3.

As described above, the unit pixel row elements composed of the pixel row in which a number of pixels are arranged, the charge transfer path provided for each pixel row, and charge-voltage conversion means provided for each charge transfer path are arranged like a two-dimensional array on the surface of the semiconductor substrate, and the signal of each charge-voltage conversion means for each unit pixel row element is read by the horizontal scanning circuit and the vertical scanning circuit, whereby the image signal of high S/N ratio can be read by random access, the global shutter is easy, and the influence of smear can be suppressed.

Though an inter transfer type in which the vertical charge transfer path and the pixels are separately provided has been exemplified in the above embodiment, a full frame type in which the charge transfer path and the pixels are commonly provided may be also used. In this case, the transistor circuit is provided at the position out of the charge transfer path.

Since a solid-state imaging device according to the invention can read the detected image signal at high speed while keeping the high S/N ratio, the invention is suitable applicable to a solid-state imaging device in which more multiple pixels for imaging a high definition image are provided or a digital camera mounting this solid-state imaging device.

While the invention has been described with reference to the exemplary embodiments, the technical scope of the invention is not restricted to the description of the exemplary embodiments. It is apparent to the skilled in the art that various changes or improvements can be made. It is apparent from the description of claims that the changed or improved configurations can also be included in the technical scope of the invention.

This application claims foreign priority from Japanese Patent Application No. 2006-300274, filed Nov. 6, 2006, the entire disclosure of which is herein incorporated by reference.

What is claimed is:

1. A solid-state imaging device comprising:
an imaging area including unit pixel row elements arranged in a two-dimensional array, each of the unit pixel row elements including a pixel row in which a plurality of pixels are arranged, a charge transfer path that transfers signal charges detected by the pixels, and a charge-voltage conversion section disposed at an end of the charge transfer path, the conversion section outputting a voltage signal in accordance with an amount of the signal charges;
a horizontal scanning circuit that designates a horizontal position, within the imaging area, of a unit pixel row element to read the voltage signal; and
a vertical scanning circuit that designates a vertical position of the unit pixel row element with the imaging area.

2. The solid-state imaging device according to claim 1, wherein the charge-voltage conversion section includes a transistor circuit disposed as a pixel lacking part in the same row as the plurality of pixels

3. The solid-state imaging device according to claim 1, the charge-voltage conversion section includes a transistor circuit shared with a plurality of first unit pixel row elements adjacent to one another.

4. The solid-state imaging device according to claim 3, wherein the plurality of first unit pixel row elements adjacent to one another are arranged in a direction perpendicular to the pixel row, and the transistor circuit shared with the plurality of first unit pixel row elements are disposed in a space between the first unit pixel row elements and second unit pixel row elements adjacent to the first unit pixel row elements in a direction of the pixel row.

5. The solid-state imaging device according to claim 1, further comprising a signal processing circuit that processing an image signal read from the imaging area, the signal processing circuit being integrated on a chip mounting the imaging area, the horizontal scanning circuit, and the vertical scanning circuit.

6. An imaging apparatus comprising:
a solid-state imaging device according to claim 1; and
a section that collectively resets unwanted charges accumulated on the charge transfer path in the imaging area.

7. An imaging apparatus comprising:
a solid-state imaging device according to claim 1; and
a control section that outputs a control instruction to the vertical scanning circuit and the horizontal scanning circuit to randomly access an image signal detected by the charge-voltage conversion section for each of the unit pixel row elements.

8. An imaging apparatus comprising:
a solid-state imaging device according to claim 1; and
a control section that instructs a pixel thinning read or pixel adding read for each of the unit pixel row elements.

9. An imaging apparatus comprising:
a solid-state imaging device according to claim 2, and
a signal processing section that interpolates an image signal of the pixel lacking part with image signals read from pixels around the pixel lacking part.
